(19) United States
(12) Patent Application Publication
(10) Pub. No.: US 2026/0335953 A1
(43) Pub. Date: Oct. 29, 2026

(54) ROLLING METHOD FOR LAMINATING THERMAL INTERFACE MATERIAL USING LAMINATION ROLLER

(71) Applicant: HORNG TERNG AUTOMATION CO., LTD., Kaohsiung City (TW)

(72) Inventor: Chang-chao TSAI, Kaohsiung City (TW)

(73) Assignee: HORNG TERNG AUTOMATION CO., LTD., Kaohsiung City (TW)

(21) Appl. No.: 19/536,307

(22) Filed: Feb. 11, 2026

(30) Foreign Application Priority Data
Apr. 23, 2025 (TW) 114115416

(51) Int. Cl. B21B 1/22; B21B 1/32; B21B 37/68; B32B 37/00

(52) U.S. Cl. CPC B21B 1/22; B21B 1/32; B21B 37/68; B32B 37/0053

(57) ABSTRACT

The present invention provides a method for rolling a thermal interface material onto a target chip using a lamination roller. The rolling method comprises performing multiple consecutive rolling operations, wherein in each rolling operation a peripheral surface of the lamination roller is used to roll a thermal interface material from a carrier tape onto a target chip. Prior to the start of each rolling operation, the initial rotational angle of the lamination roller is adjusted by at least a predetermined angle relative to the initial rotational angle of the preceding rolling operation, thereby ensuring uniform pressure distribution on the lamination roller, reducing the risk of localized deformation and delamination, and extending the service life of the lamination roller.

### CROSS-REFERENCE TO RELATED APPLICATIONS

This application claims priority to Taiwan Application Serial Number 114115416, filed on Apr. 23, 2025, which is incorporated herein by reference.

### FIELD OF INVENTION

The present invention relates to a rolling method and more particularly, to a method for laminating a thermal interface material onto a semiconductor chip using a lamination roller, thereby extending the service life of the roller and improving rolling uniformity.

### BACKGROUND OF INVENTION

Attaching a thermal interface material (TIM) to a chip is an important step in semiconductor manufacturing. A common approach is to orient a carrier tape that carries the thermal interface material toward the chip, and to use a lamination roller to apply pressure to the carrier tape while performing reciprocating rolling, thereby laminating the thermal interface material onto the chip surface.

However, conventional rolling methods using lamination rollers for thermal interface materials suffer from non-uniform wear on the roller surface. During reciprocating rolling, only a small portion of the roller periphery bears the lamination pressure, while the remaining portions remain unused. Prolonged use causes the stressed portion to experience continuous mechanical stress, which may lead to roller deformation and even delamination of the roller from its core, thereby reducing the service life of the roller.

### SUMMARY OF INVENTION

one object of the present invention is to provide a rolling method for laminating thermal interface material using lamination roller, which addresses the problems present in the prior art.

According to the aforementioned object, a rolling method for laminating a thermal interface material using a lamination roller. The method includes performing multiple consecutive rolling operations, in which a peripheral portion of the lamination roller is used in each rolling operation to roll a thermal interface material from a carrier tape onto a target chip. Prior to the start of each rolling operation, the initial rotational angle of the lamination roller is adjusted by at least a predetermined angle relative to the initial rotational angle of the preceding rolling operation.

According to an embodiment of the present invention, the lamination roller contacts the carrier tape using a peripheral portion of its surface. Different peripheral portions of the lamination roller are engaged in two consecutive rolling operations, and the engaged portions do not completely overlap.

According to an embodiment of the present invention, after completing a rolling operation and returning to the start position on the carrier tape, the lamination roller rolls an additional distance in the same direction as its last rolling movement.

According to an embodiment of the present invention, a pressure applied to the carrier tape while the lamination roller rolls the additional distance in the same direction as its last rolling movement is less than or equal to a pressure applied to the carrier tape during the preceding rolling operation.

According to an embodiment of the present invention, after completing a predetermined rolling stroke on the carrier tape, the lamination roller rolls an additional distance so as to rotate the lamination roller by a predetermined angle.

According to an embodiment of the present invention, prior to performing the rolling operation, the lamination roller may be rotated to a predetermined angle by an external force, so that different portions of its peripheral surface contact the carrier tape during successive rolling operations.

According to an embodiment of the present invention, before performing the rolling operation, the carrier tape is cut, and the rolling operation is performed using the lamination roller over the region between two opposing free ends of the carrier tape.

According to an embodiment of the present invention, the method may further include a vacuum holding operation, in which the cut carrier tape is held on the target chip prior to performing the rolling operation so that the thermal interface material on the carrier tape is aligned with the target chip.

According to an embodiment of the present invention, the method may further include a setting operation for determining the initial rotational angle between consecutive rolling operations, based on the length of the target chip and the ratio of the peripheral length of the lamination roller used in each rolling operation to the total circumference of the lamination roller.

According to an embodiment of the present invention, between consecutive rolling operations, the change in the initial rotational angle of the lamination roller relative to the preceding rolling operation is greater than 0 degrees.

According to an embodiment of the present invention, the start position and end position of a predetermined rolling stroke of the rolling operation are set based on the circumference of the target chip and the size of the lamination roller.

According to an embodiment of the present invention, the start position and the end position are set at opposite ends of the target chip.

According to the aforementioned embodiments of the present invention, the rolling method of the present invention, in which a lamination roller is used to roll a thermal interface material, can extend the service life of the lamination roller and improve bonding quality. By adjusting the initial rotational angle of the lamination roller prior to each rolling operation, it is ensured that different portions of the roller periphery bear pressure during each rolling operation, thereby extending the service life of the lamination roller. The rolling method of the present invention is applicable to semiconductor processing equipment, such as equipment for bonding a thermal interface

material onto a target chip, and can achieve the objectives of the invention without requiring modification of the existing apparatus or the structure of the lamination roller.

### DESCRIPTION OF DRAWINGS

FIG. 1 is a schematic diagram of a rolling operation in accordance with an embodiment of the present invention.

FIG. 2 is a schematic diagram illustrating the steps of the rolling operation in accordance with an embodiment of the present invention.

FIG. 3 is a schematic diagram continuing from FIG. 2, illustrating further steps of the rolling operation in accordance with an embodiment of the present invention.

### DETAILED DESCRIPTION OF PREFERRED EMBODIMENTS

In order to make the above and other objects, features, and advantages of the present invention more comprehensible, preferred embodiments of the present invention will be described below in detail together with the attached drawings. Furthermore, the directional terms used in the present invention, for example, up, down, top, bottom, front, back, left, right, inside, outside, side, around, central, horizontal, transverse, vertical, longitudinal, axial, radial direction, the uppermost layer, or the lowermost layer, etc. are only the directions shown in the attached drawings. Therefore, the directional terms are only used to illustrate and express the present invention, but not to limit the present invention.

The present invention provides a rolling method for laminating a thermal interface material using a lamination roller, which is applicable to equipment configured to laminate a thermal interface material from a carrier tape onto a target chip. The rolling method of the present invention can be performed without requiring modification to the existing rolling equipment.

The rolling method according to the present invention comprises multiple consecutive rolling operations performed by a lamination roller of the

rolling equipment. The method is characterized in that, prior to the start of each rolling operation, an initial rotational angle of the lamination roller is adjusted by at least a predetermined angle relative to an initial angle of the preceding rolling operation, thereby ensuring uniform loading of the lamination roller, reducing the risk of local deformation and delamination, and extending the service life of the lamination roller.

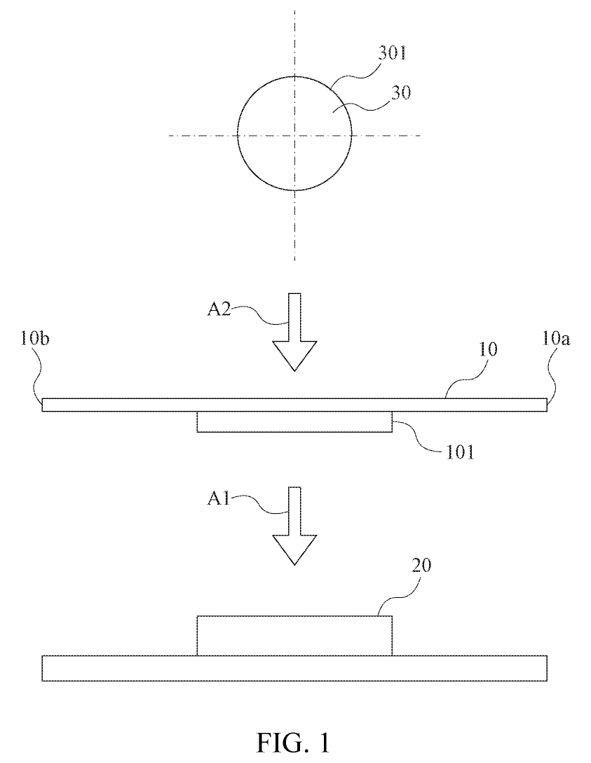

Referring to FIG. 1, before each rolling operation, as shown by arrow A1, a pre-cut carrier tape 10 is placed on the target chip 20 by vacuum holding means, such as a vacuum or negative pressure device, and the thermal interface material 101 on the carrier tape 10 is aligned with the target chip 20. Then, as shown by arrow A2 in FIG. 1, a lamination roller 30 of the rolling equipment is driven downward to contact the carrier tape 10, and the peripheral surface 301 of the lamination roller 30 rolls along a predetermined path on the carrier tape 10, thereby laminating the thermal interface material 101 onto the target chip 20.

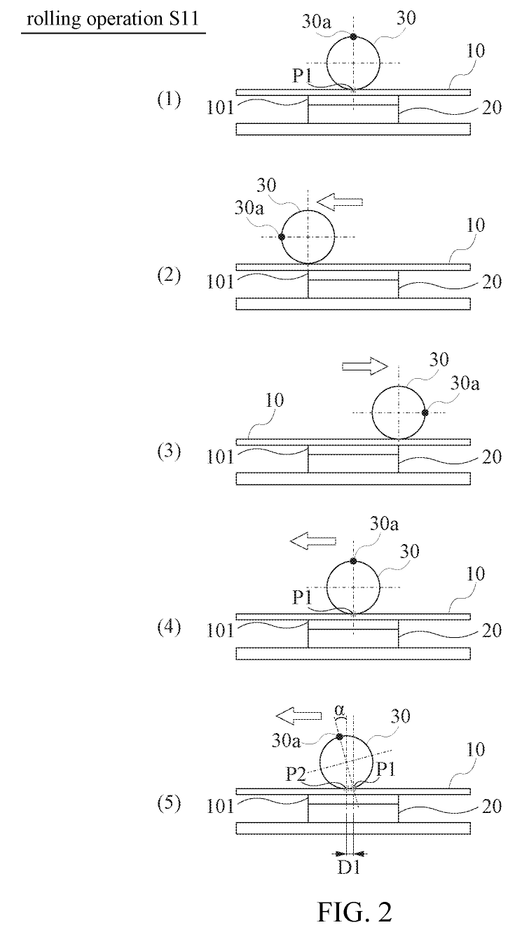

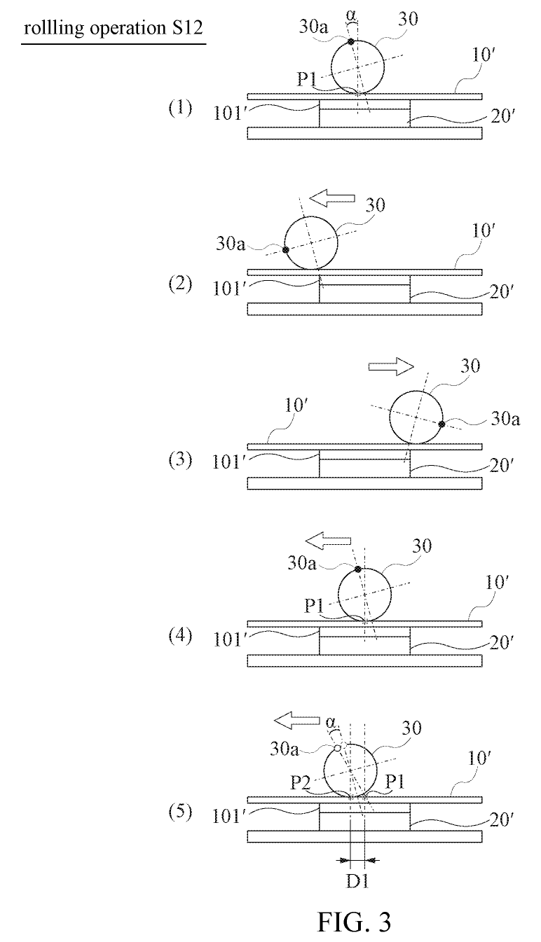

To illustrate changes in the initial rotational angle of the lamination roller 30 between consecutive rolling operations, rolling operation S11 and rolling operation S12, respectively shown in FIGS. 2, and 3, are used as examples. It should be noted that the rolling operation S11 and the rolling operation S12 do not limit the total number of rolling operations, and the actual number of rolling operations may be adjusted according to operational requirements, and the durability and usage conditions of the lamination roller.

Referring to FIG. 2, FIG. 2 illustrates the flow of rolling operation S11. For illustrative purposes, a reference mark 30a is shown on the lamination roller 30 to indicate its rotation. The mark 30ais for illustration only and is not necessarily present in actual use.

As shown in FIG. 2(1), the pre-cut carrier tape 10 is placed on the target chip 20 using vacuum holding, such that the thermal interface material 101 is aligned with the target chip 20. The lamination roller 30 descends to contact the carrier tape 10 and is positioned at start position P1, with an initial rotational angle of 0 degrees. Next, as shown in FIG. 2(2), the lamination roller 30 rolls to the left side of the carrier tape 10; then, as shown in FIG. 2(3), the lamination roller 30 rolls to the right side of the carrier tape 10; and finally, as shown in FIG. 2(4), the lamination roller 30 rolls back to the start position P1, completing a predetermined rolling stroke. As shown in FIG. 2(5), after completing the predetermined rolling stroke, the lamination roller 30 rolls an additional distance D1 to position P2, thereby rotating by a predetermined angle α.

As shown in FIG. 2(5), after the lamination roller 30 completes the rolling operation and rotates by the predetermined angle α, it is raised back to the set position of the rolling equipment while maintaining the predetermined rotational angle α, in preparation for the next rolling operation S12.

Referring to FIG. 3, FIG. 3 illustrates the process of rolling operation S12, which is performed consecutively after rolling operation S11. As shown in FIG. 3(1), another pre-cut carrier tape 10' is placed on a target chip 20' using vacuum holding means, such that the thermal interface material 101' is aligned with the target chip 20'. The lamination roller 30 descends to contact the carrier tape 10' at start position P1, with an initial rotational angle of α. Next, as shown in FIG. 3(2), the lamination roller 30 rolls to the left side of the carrier tape 10'; then, as shown in FIG. 3(3), the lamination roller 30 rolls to the right side the carrier tape 10'; and finally, as shown in FIG. 3(4), the lamination roller 30 returns to start position P1, completing the predetermined rolling stroke. As shown in FIG. 3(5), after completing the predetermined rolling stroke, the lamination roller 30 rolls an additional distance D1 to position P2, thereby rotating by the predetermined angle α and preparing for the next rolling operation.

Thus, during rolling operation S11, the lamination roller 30 has an initial rotational angle of 0 degrees, so that a specific portion of its peripheral surface contacts the carrier tape 10 during rolling. In contrast, during rolling operation S12, the lamination roller 30 has an initial rotational angle of α and follows the same rolling stroke as in S11, so that a different region of its peripheral surface comes into contact with the carrier tape 10. Accordingly, in consecutive rolling operations, the peripheral contact regions of the lamination roller 30 do not completely overlap. That is, between any two consecutive rolling operations, the initial rotational angle of the lamination roller 30 is changed relative to the initial rotational angle of the preceding operation by more than 0 degrees, ensuring that different portions of the peripheral surface bear the load during each rolling operation. This prevents uneven wear or potential damage caused by localized overuse of the lamination roller.

By having the lamination roller further travel a certain distance after completing the predetermined rolling stroke, thereby rotating to a new initial angle, different contact surfaces are used in successive rolling operations, allowing the entire periphery of the lamination roller to be utilized more evenly. This prevents prolonged stress concentration in a single region and extends the roller’s service life. In one embodiment, after the lamination roller 30 completes the rolling stroke and returns to the start position on the carrier tape 10, the lamination roller 30 rolls a distance D1 in its last travel direction, thereby quickly changing its initial rotational angle and improving overall operational efficiency. Additionally, in some cases, the pressure applied by lamination roller 30 to carrier tape 10 while rolling the distance D1 may be equal to or less than the pressure applied during the preset rolling stroke, thereby avoiding unnecessary pressure buildup. It should be noted that in the illustrated embodiments, the start position P1 of the rolling stroke is located at the center of the target chip 20, and the lamination roller rolls toward the opposite left and right sides to perform the rolling. This arrangement is merely for illustrative purposes only, and is not intended to limit the scope of the invention. In other embodiments, the start and end positions of the predetermined rolling stroke may be adjusted and set based on factors such as the perimeter of the target chip and the size of the lamination roller. For example, the start and end positions may be set at opposite ends of the target chip, such as the left and right edges. In addition, the rolling direction of the lamination roller, the number of reciprocations, and the additional rolling distance may be configured according to actual requirements.

In one embodiment, the rolling method may further include a setting operation. The setting operation determines the initial rotational angle between consecutive rolling operations based on factors such as the length of the target chip and the proportion of the lamination roller’s peripheral surface used during each rolling operation relative to its total circumference. This setting ensures more uniform use of the lamination roller and may define a cycle in which, after multiple rolling operations, the initial rotational angle returns to its original position (e.g., 0 degrees), thereby ensuring uniform loading over the entire roller circumference.

In one example, the lamination roller may start the first rolling operation with an initial rotational angle of 0 degrees, using one quarter of its peripheral surface to contact the carrier tape. During the second rolling operation, the initial rotational angle is set to 90 degrees, and a different quarter of the peripheral surface contacts the carrier tape. This pattern continues for the third and fourth rolling operations, using sequential quarters of the peripheral surface. After completing the fourth rolling operation, the lamination roller returns to the initial rotational angle of 0 degrees, thereby completing a full cycle. Accordingly, during four consecutive rolling operations, different portions of the lamination roller's peripheral surface are engaged, which significantly improves upon the prior art where only the same portion is repeatedly used, leading to excessive wear. It should be emphasized that this example is illustrative only and does not limit the scope of the invention. In practice, the initial rotational angle of the lamination roller for each rolling operation can be set as needed, and the portions of the peripheral surface used in each operation may partially overlap. The key requirement is that different portions of the roller's periphery are engaged in consecutive rolling operations, thereby effectively extending the service life of the lamination roller.

In the above embodiments, a conventional rolling apparatus may be used, with the rolling operation performed by configuring predetermined rolling strokes to achieve the desired operation. In other embodiments, the lamination roller may be rotated to a predetermined initial angle by an external force before a rolling operation is performed, so that different peripheral portions of the roller contact the carrier tape during each rolling operation. For example, external mechanisms such as a stepper motor, cylinder, or other mechanical device may be used to rotate the lamination roller and set different initial rotational angles for consecutive rolling operations.

Since the rolling method is performed on the pre-cut carrier tape, rolling occurs between two opposing free ends, so that the lamination roller does not cause the carrier tape to become tensioned or loosened during rolling and improving alignment accuracy and bonding quality. Referring again to FIG. 1, before the rolling operation, the carrier tape 10 has been cut so that the rolling is performed between two opposing free ends of the carrier tape (e.g., free end 10a and free end 10b), ensuring that the lamination roller does not introduce tension or slack in the carrier tape, thereby improving alignment accuracy and bonding quality. In further embodiments, the method may include a vacuum holding operation, in which the pre-cut carrier tape 10 is held on the target chip 20 by vacuum prior to rolling, to ensure proper alignment of the thermal interface material 101 with the target chip 20 and to improve process stability.

As described in the foregoing embodiments, the rolling method of the present invention, in which a lamination roller is used to roll a thermal interface material, can extend the service life of the lamination roller and improve bonding quality. By adjusting the initial rotational angle of the lamination roller prior to each rolling operation, different portions of the roller periphery bear pressure during successive rolling operations, thereby extending the roller’s service life. The rolling method of the present invention is applicable to semiconductor processing equipment, such as equipment for bonding a thermal interface material onto a target chip, and can achieve the objectives of the invention without requiring modification of the existing apparatus or the structure of the lamination roller.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

1. A rolling method for laminating a thermal interface material using a lamination roller, comprising the steps of: performing multiple consecutive rolling operations, wherein in each rolling operation a peripheral portion of the lamination roller is used to roll a thermal interface material from a carrier tape onto a target chip; and prior to the start of each rolling operation, adjusting an initial rotational angle of the lamination roller by at least a predetermined angle relative to the initial rotational angle of a preceding rolling operation.

2. The rolling method according to claim 1, wherein the lamination roller contacts the carrier tape using a peripheral portion of the lamination roller, and wherein different peripheral portions of the lamination roller are engaged in two consecutive rolling operations, the engaged portions do not completely overlap.

3. The rolling method according to claim 1, wherein, after the lamination roller completes a rolling operation and returns to a start position on the carrier tape, the lamination roller rolls an additional distance in the same direction as its last rolling movement.

4. The rolling method according to claim 3, wherein a pressure applied to the carrier tape while the lamination roller rolls the additional distance in the same direction as its last rolling movement is less than or equal to a pressure applied to the carrier tape during the preceding rolling operation.

5. The rolling method according to claim 1, wherein, after the lamination roller completes a predetermined rolling stroke on the carrier tape, the lamination roller rolls an additional distance so as to rotate the lamination roller by a predetermined angle.

6. The rolling method according to claim 1, wherein, prior to performing the rolling operation, the lamination roller is rotated to a predetermined angle by an external force so that different portions of its peripheral surface contact the carrier tape during successive rolling operations.

7. The rolling method according to claim 1, wherein, prior to performing the rolling operation, the carrier tape is cut, and the rolling operation is performed using the lamination roller between two opposing free ends of the carrier tape.

8. The rolling method according to claim 7, further comprising a vacuum holding operation, wherein the carrier tape that is cut is held on the target chip prior to performing the rolling operation so that a thermal interface material on the carrier tape is aligned with the target chip.

9. The rolling method according to claim 1, further comprising a setting operation for determining the initial rotational angle between consecutive rolling operations based on a length of the target chip and a ratio of a peripheral length of the lamination roller used in each rolling operation to a total circumference of the lamination roller.

10. The rolling method according to claim 1, wherein the adjustment of the initial rotational angle of the lamination roller between consecutive rolling operations is greater than 0 degrees.

11. The rolling method according to claim 1, wherein a start position and an end position of a predetermined rolling stroke of the rolling operation are set based on a circumference of the target chip and a size of the lamination roller.

12. The rolling method according to claim 11, wherein the start position and the end position are set at opposite ends of the target chip.
